(19) United States
(12) Patent Application Publication
(10) Pub. No.: US 2026/0307220 A1
(43) Pub. Date: Oct. 8, 2026

(54) ELECTRIC RATCHET WRENCH

(71) Applicant: INFAR INDUSTRIAL CO., LTD., CHANG-HWA (TW)

(72) Inventor: Tai-Hung CHEN, CHANG-HWA (TW)

(21) Appl. No.: 19/171,208

(22) Filed: Apr. 5, 2025

(51) Int. Cl. B25B 21/00

(52) U.S. Cl. CPC B25B 21/004

(57) ABSTRACT

An electric ratchet wrench makes an actuating assembly pivot between two positions through an eccentric rod and a swing member. When the positioning portion is in a first position, a positioning member abuts against a first positioning groove, a second protrusion is in a first corner, a first protrusion is away from a second corner, a second ratchet block disengages from a ratchet ring, and the elastic member pushes the first ratchet block to make it engage with the ratchet ring. When the positioning portion is in a second position, the positioning member abuts against a second positioning groove, the second protrusion is away from the first corner, the first protrusion is in the second corner, the first ratchet block disengages from the ratchet ring, and the elastic member pushes the second ratchet block to make it engage with the ratchet ring, thus achieving a reversing effect.

### FIELD OF THE INVENTION

The present invention relates to a wrench, and more particularly to an electric ratchet wrench.

### DESCRIPTION OF RELATED ART

As a representative product of the new generation of maintenance tools, electric ratchet wrenches currently on the market still have many aspects to be improved. The most prominent issue lies in the overly complex design of the direction switching mechanism, which causes significant difficulties during manufacturing and assembly. The large number of components not only substantially increases production costs but also raises the probability of malfunctions.

### SUMMARY OF THE INVENTION

The present invention provides an electric ratchet wrench, and the main objective thereof is to simplify the structure, facilitate maintenance, and reduce the maintenance cost.

To achieve the above objective, an electric ratchet wrench provided by the invention comprises:

a body includes a handle portion and an assembly portion connected to each other, the handle portion includes a through bore, the assembly portion including a first clamping piece and a second clamping piece, wherein a clamping space is formed between the first clamping piece and the second clamping piece, one end of the through bore communicates with the clamping space, both the first clamping piece and the second clamping piece include a through hole respectively, the first clamping piece includes a perforation, and the perforation penetrates the first clamping piece and communicates with the clamping space;

an eccentric rod inserted through the through bore, wherein one end of the eccentric rod includes an eccentric shaft, and the eccentric shaft extends out of the through bore;

a swing member disposed in the clamping space of the body, and including a first end and a second end opposite to each other, wherein the first end includes a receiving groove, the eccentric shaft extends into the receiving groove, the swing member further includes a ratchet hole that is aligned with the through holes of the first clamping piece and the second clamping piece, the swing member includes a ratchet tooth groove, and the ratchet tooth groove is communicated with the ratchet hole;

a ratchet ring disposed in the ratchet hole;

an actuating assembly including an actuating portion, an extension portion and a positioning portion, wherein the actuating portion is exposed outside the body, one end of the extension portion is connected to the actuating portion, the extension portion is inserted through the perforation of the first clamping piece, another end of the extension portion is connected to one side of the positioning portion, and the actuating portion and the positioning portion is capable of pivoting relative to the swing member between a first position and a second position;

another side of the positioning portion that is not connected to the extension portion includes a limiting groove, the limiting groove is communicated with the ratchet tooth groove, and includes a first corner and a second corner located on opposite sides of the limiting groove;

a ratchet block assembly disposed in the ratchet tooth groove, and including a first ratchet block, a second ratchet block and a second elastic member, wherein one end of the second elastic member abuts against the first ratchet block, another end of the second elastic member abuts against the second ratchet block, the first ratchet block includes a first protrusion, the second ratchet block includes a second protrusion, the first protrusion and the second protrusion extend into the limiting groove, when the positioning portion is in the first position, the second protrusion is located at the first corner, and the first protrusion is away from the second corner, when the positioning portion is in the second position, the second protrusion is away from the first corner, and the first protrusion is located at the second corner.

From the above, it can be known that the present invention primarily drives the swing member to swing through the eccentric rod, allowing the actuating portion and the positioning portion of the actuating assembly to pivot relative to the swing member between the first position and the second position. When the positioning portion is in the first position, the positioning member abuts against the first positioning groove, the second protrusion is located at the first corner, and the first protrusion is away from the second corner, so that the second ratchet block is disengaged from the ratchet ring, and the elastic member pushes against the first ratchet block, allowing the first ratchet block to engage with the ratchet ring. When the positioning portion is in the second position, the positioning member abuts against the second positioning groove, the second protrusion is away from the first corner, and the first protrusion is located at the second corner, so that the first ratchet block is disengaged from the ratchet ring, and the elastic member pushes against the second ratchet block, allowing the second ratchet block to engage with the ratchet ring, thus achieving a reversing effect. Since fewer components are required to achieve the reversing effect, the structure is simplified, and maintenance is facilitated.

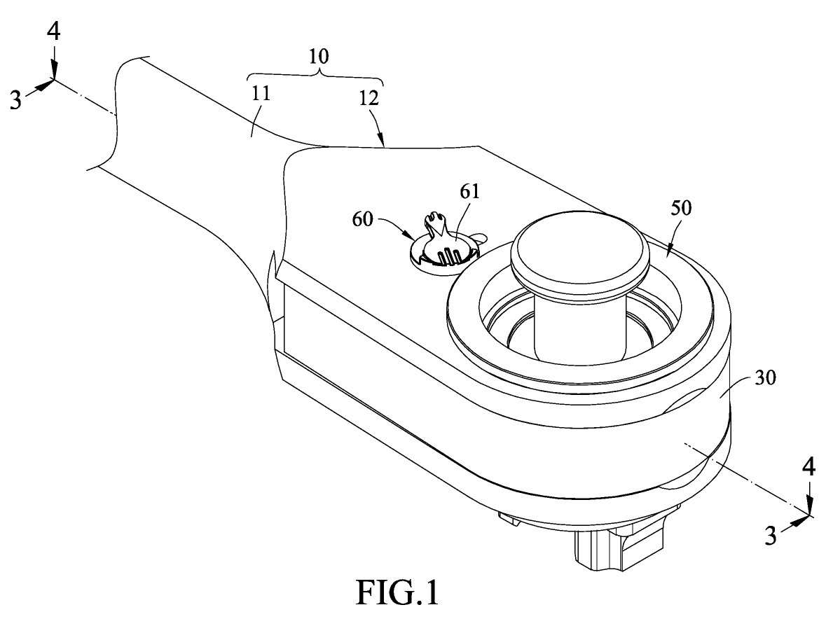

FIG. 1 is a perspective view of the electric ratchet wrench of the present invention;

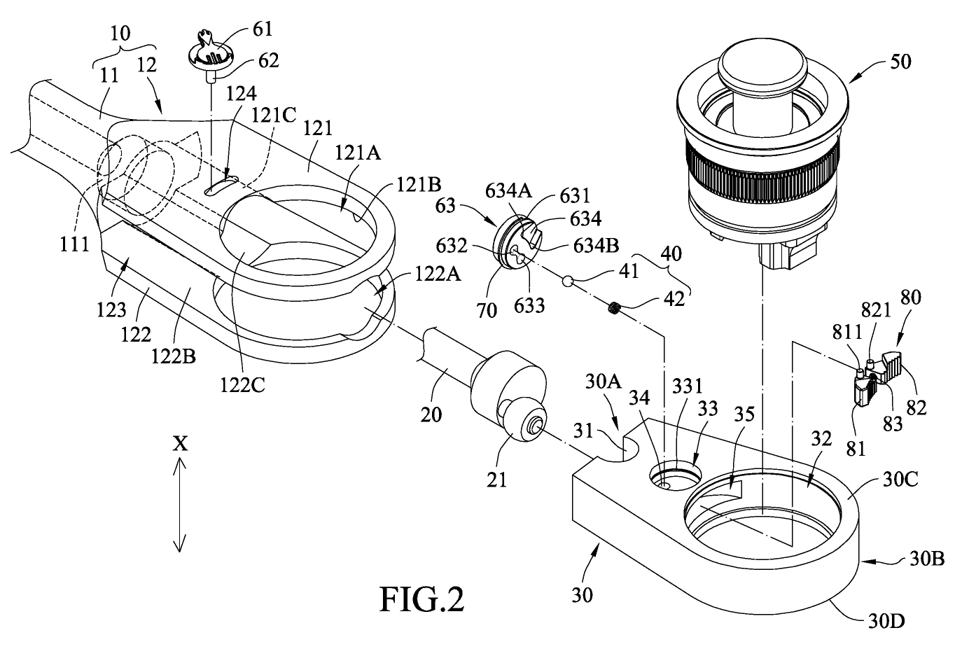

FIG. 2, an exploded view of the electric ratchet wrench of the present invention;

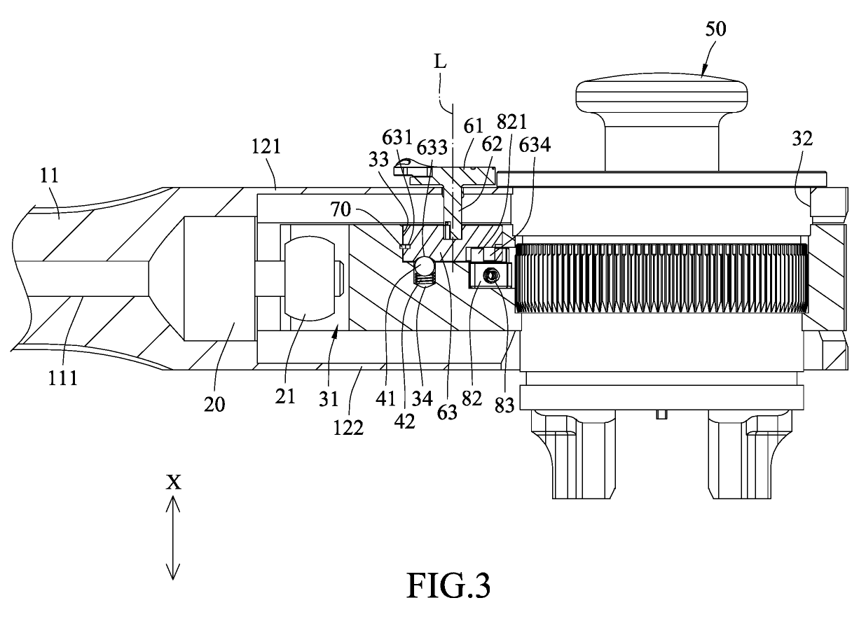

FIG. 3, a cross-sectional view of the electric ratchet wrench of the present invention;

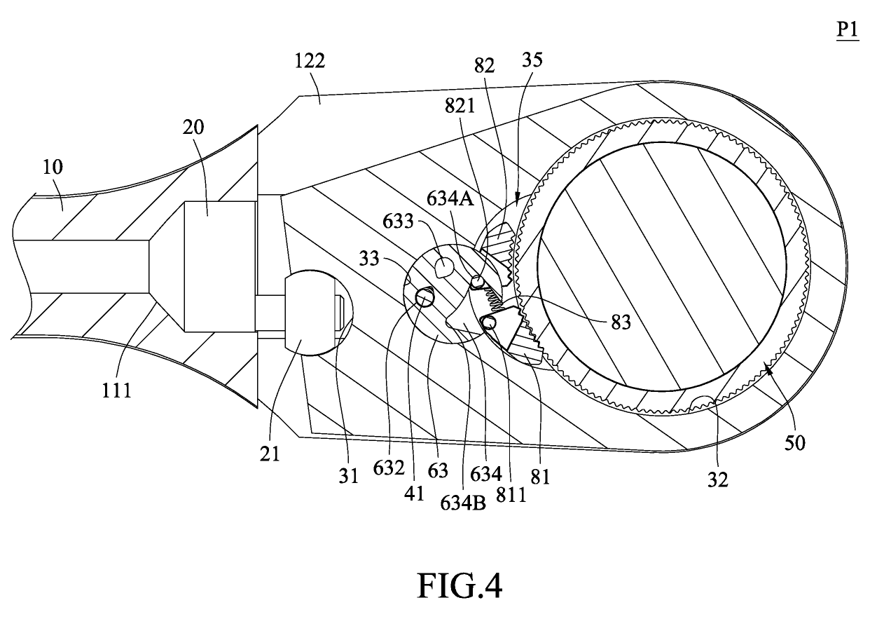

FIG. 4, a cross-sectional view of the electric ratchet wrench of the present invention in the first position;

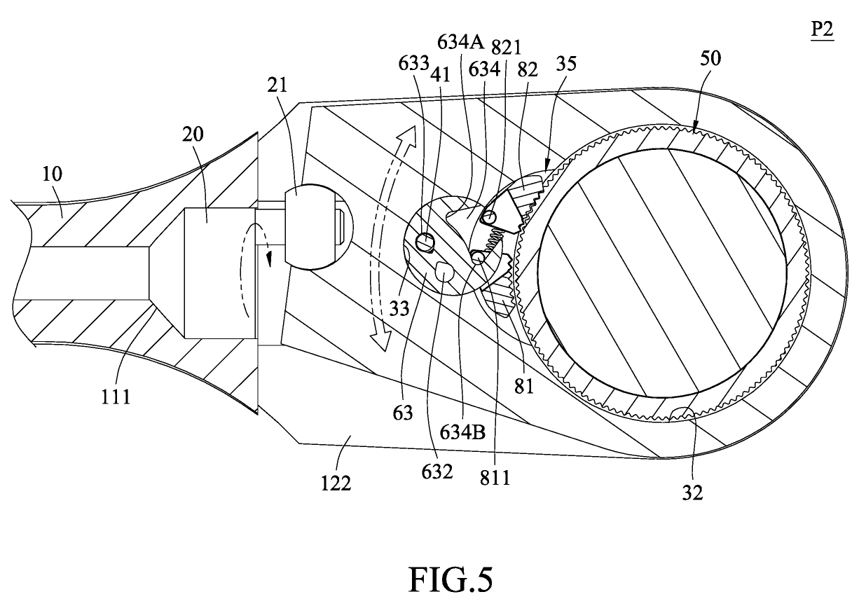

FIG. 5, a cross-sectional view of the electric ratchet wrench of the present invention in the second position;

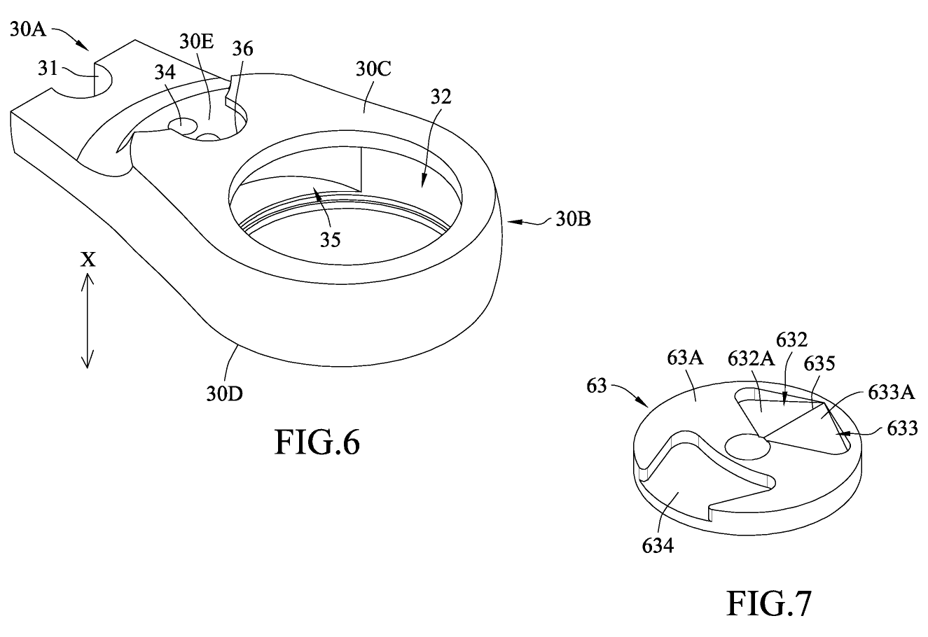

FIG. 6, a partial perspective view of another embodiment of the electric ratchet wrench of the present invention; and

FIG. 7, a partial perspective view of another embodiment of the electric ratchet wrench of the present invention.

### DETAILED DESCRIPTION OF THE INVENTION

The present invention provides an electric ratchet wrench, as shown in FIGS. 1-5, which includes:

A body 10 includes a handle portion 11 and an assembly portion 12 connected to each other. The handle portion 11 includes a through bore 111, and the through bore 111 penetrates the handle portion 11 along the extending direction of the handle portion 11. The assembly portion 12 includes a first clamping piece 121 and a second clamping piece 122, which are spaced apart to form a clamping space 123. One end of the through bore 111 communicates with the clamping space 123. Both the first clamping piece 121 and the second clamping piece 122 have a through hole 121A and 122A respectively, and the through holes 121A and 122A of the first clamping piece 121 and the second clamping piece 122 are aligned with each other. A surface of the first clamping piece 121 facing the second clamping piece 122 is a first inner surface 121B, and a surface of the second clamping piece 122 facing the first clamping piece 121 is a second inner surface 122B. The first inner surface 121B includes a first groove 121C, the second inner surface 122B includes a second groove 122C, and the first clamping piece 121 includes a perforation 124. The perforation 124 penetrates the first clamping piece 121 and communicates with the clamping space 123.

An eccentric rod 20 is inserted through the through bore 111. One end of the eccentric rod 20 includes an eccentric shaft 21, and the eccentric shaft 21 extends out of the through bore 111. The first groove 121C and the second groove 122C provide space for the rotation of the eccentric shaft 21. In this way, there is no need to thicken the first clamping piece 121 and the second clamping piece 122, and the first groove 121C and the second groove 122C can achieve the effect of reducing the overall thickness of the wrench.

A swing member 30 is disposed in the clamping space 123 of the body 10. The first clamping piece 121, the swing member 30 and the second clamping piece 122 are arranged along an axial direction X. The swing member 30 includes a first end 30A and a second end 30B opposite to each other. The first end 30A includes a receiving groove 31, and the receiving groove 31 faces the through bore 111. The eccentric shaft 21 extends into the receiving groove 31. The swing member 30 further includes a ratchet hole 32 that penetrates along the axial direction X. The ratchet hole 32 is closer to the second end 30B than to the first end 30A. The ratchet hole 32 penetrates a top end surface 30C and a bottom end surface 30D of the swing member 30. The top end surface 30C faces the first inner surface 121B, and the bottom end surface 30D faces the second inner surface 122B. The ratchet hole 32 is aligned with the through holes 121A and 122A of the first clamping piece 121 and the second clamping piece 122. The swing member 30 is provided with a groove 33 along the axial direction X of an imaginary pivot axis L. The groove 33 is provided with a first recessed edge 331 on the inner peripheral edge thereof in the radial direction of the imaginary pivot axis L. The swing member 30 includes a positioning-member accommodating groove 34 and a ratchet tooth groove 35. The positioning-member accommodating groove 34 and the groove 33 are arranged along the axial direction X and communicate with each other, and the ratchet tooth groove 35 is communicated with the groove 33 and the ratchet hole 32.

A positioning assembly 40 includes a positioning member 41 and a first elastic member 42. The first elastic member 42 is disposed in the positioning-member accommodating groove 34, with one end of the first elastic member 42 abutting against the bottom of the positioning-member accommodating groove 34, and the other end abutting against the positioning member 41. The positioning member 41 can be partially disposed in the positioning-member accommodating groove 34 and partially protrude out of the positioning-member accommodating groove 34.

A ratchet ring 50 is disposed in the ratchet hole 32.

An actuating assembly 60 includes an actuating portion 61, an extension portion 62 and a positioning portion 63. The actuating portion 61 abuts against the first clamping piece 121, and is exposed outside the body 10. One end of the extension portion 62 is connected to the actuating portion 61, the extension portion 62 is inserted through the perforation 124 of the first clamping piece 121, and the other end of the extension portion 62 is connected to the positioning portion 63, so that the actuating portion 61 can rotate synchronously with the positioning portion 63. The positioning portion 63 is disposed in the groove 33, so that the actuating portion 61 and the positioning portion 63 can pivot relative to the swing member 30 between a first position P1 and a second position P2.

The positioning portion 63 is provided with a second recessed edge 631 on an outer peripheral edge thereof in the radial direction of the imaginary pivot axis L. A snap ring 70 is sleeved on the positioning portion 63, and is disposed in the first recessed edge 331 and the second recessed edge 631. The extension portion 62 is connected to one side of the positioning portion 63, while the other side of the positioning portion 63 includes a first positioning groove 632, a second positioning groove 633 and a limiting groove 634. The limiting groove 634 is communicated with the ratchet tooth groove 35. When the actuating portion 61 and the positioning portion 63 are in the first position P1, as shown in FIG. 4, the positioning member 41 abuts against the first positioning groove 632. When the actuating portion 61 and the positioning portion 63 are in the second position P2, as shown in FIG. 5, the positioning member 41 abuts against the second positioning groove 633. The limiting groove 634 includes a first corner 634A and a second corner 634B, which are located on opposite sides of the limiting groove 634.

A ratchet block assembly 80 is disposed in the ratchet tooth groove 35, and includes a first ratchet block 81, a second ratchet block 82 and a second elastic member 83. One end of the second elastic member 83 abuts against the first ratchet block 81, and the other end of the second elastic member 83 abuts against the second ratchet block 82. The first ratchet block 81 includes a first protrusion 811, and the second ratchet block 82 includes a second protrusion 821. The first protrusion 811 and the second protrusion 821 extend into the limiting groove 634 along the axial direction X. As shown in FIG. 4, when the actuating portion 61 and the positioning portion 63 are in the first position P1, the second protrusion 821 is located at the first corner 634A, and the first protrusion 811 is away from the second corner 634B, so that the second ratchet block 82 is disengaged from the ratchet ring 50, and the elastic member 83 pushes against the first ratchet block 81, allowing the first ratchet block 81 to engage with the ratchet ring 50. When the actuating portion 61 and the positioning portion 63 are in the second position P2, as shown in FIG. 5, the second protrusion 821 is away from the first corner 634A, and the first protrusion 811 is located at the second corner 634B, so that the first ratchet block 81 is disengaged from the ratchet ring 50, and the elastic member 83 pushes against the second ratchet block 82, allowing the second ratchet block 82 to engage with the ratchet ring 50.

In another embodiment, as shown in FIGS. 2 and 6, the swing member 30 is disposed in the clamping space 123 of the body 10, and the first clamping piece 121, the swing member 30 and the second clamping piece 122 are arranged along an axial direction X. The swing member 30 includes a first end 30A and a second end 30B opposite to each other. The first end 30A includes the receiving groove 31, the receiving groove 31 faces the through bore 111, and the eccentric shaft 21 extends into the receiving groove 31. The swing member 30 further includes a ratchet hole 32 that penetrates along the axial direction X. The ratchet hole 32 is closer to the second end 30B than to the first end 30A. The ratchet hole 32 penetrates a top end surface 30C and a bottom end surface 30D of the swing member 30. The top end surface 30C faces the first inner surface 121B, and the bottom end surface 30D faces the second inner surface 122B. The ratchet hole 32 is aligned with the through holes 121A and 122A of the first clamping piece 121 and the second clamping piece 122. The swing member 30 further includes a secondary top surface 30E, and the positioning-member accommodating groove 34 is located on the secondary top surface 30E. A slot 36 is formed between the secondary top surface 30E and the top end surface 30C. The slot 36 is communicated with the ratchet tooth groove 35, and the ratchet tooth groove 35 is communicated with the ratchet hole 32.

The positioning portion 63 is disposed in the slot 36, allowing the actuating portion 61 and the positioning portion 63 to pivot relative to the swing member 30 between the first position P1 and the second position P2, and the limiting groove 634 is communicated with the ratchet tooth groove 35.

In another embodiment, as shown in FIG. 7, a ridge portion 635 is provided between the first positioning groove 632 and the second positioning groove 633 of the positioning portion 63. The first positioning groove 632 and the second positioning groove 633 are triangular. The first positioning groove 632 corresponds to a first groove bottom 632A, and the second positioning groove 633 corresponds to a second groove bottom 633A. The first groove bottom 632A and the second groove bottom 633A are triangular and inclined. One end of the first groove bottom 632A and one end of the second groove bottom 633A jointly form the ridge portion 635, which is a sharp angle where the first groove bottom 632A and the second groove bottom 633A are connected. One side of the positioning portion 63 that is not connected to the extension portion 62 includes a bottom surface 63A, which is coplanar with the ridge portion 635. The ridge portion 635 enhances the positioning effect of the positioning member 41, making it easier for the user to feel the position change of the positioning portion 63.

From the above, it can be known that the present invention primarily drives the swing member 30 to swing through the eccentric rod 20, allowing the actuating portion 61 and the positioning portion 63 of the actuating assembly 60 to pivot relative to the swing member 30 between the first position P1 and the second position P2. When the positioning portion 63 is in the first position P1, the positioning member 41 abuts against the first positioning groove 632, the second protrusion 821 is located at the first corner 634A, and the first protrusion 811 is away from the second corner 634B, so that the second ratchet block 82 is disengaged from the ratchet ring 50, and the elastic member 83 pushes against the first ratchet block 81, allowing the first ratchet block 81 to engage with the ratchet ring 50. When the positioning portion 63 is in the second position P2, the positioning member 41 abuts against the second positioning groove 633, the second protrusion 821 is away from the first corner 634A, and the first protrusion 811 is located at the second corner 634B, so that the first ratchet block 81 is disengaged from the ratchet ring 50, and the elastic member 83 pushes against the second ratchet block 82, allowing the second ratchet block 82 to engage with the ratchet ring 50, thus achieving a reversing effect. Since fewer components are required to achieve the reversing effect, the structure is simplified, and maintenance is facilitated.

1. An electric ratchet wrench, comprising:
a body including a handle portion and an assembly portion connected to each other, the handle portion including a through bore, the assembly portion including a first clamping piece and a second clamping piece, wherein a clamping space is formed between the first clamping piece and the second clamping piece, one end of the through bore communicates with the clamping space, both the first clamping piece and the second clamping piece include a through hole respectively, the first clamping piece includes a perforation, and the perforation penetrates the first clamping piece and communicates with the clamping space;
an eccentric rod inserted through the through bore, wherein one end of the eccentric rod includes an eccentric shaft, and the eccentric shaft extends out of the through bore;
a swing member disposed in the clamping space of the body, and including a first end and a second end opposite to each other, wherein the first end includes a receiving groove, the eccentric shaft extends into the receiving groove, the swing member further includes a ratchet hole that is aligned with the through holes of the first clamping piece and the second clamping piece, the swing member includes a ratchet tooth groove, and the ratchet tooth groove is communicated with the ratchet hole;
a ratchet ring disposed in the ratchet hole;
an actuating assembly including an actuating portion, an extension portion and a positioning portion, wherein the actuating portion is exposed outside the body, one end of the extension portion is connected to the actuating portion, the extension portion is inserted through the perforation of the first clamping piece, another end of the extension portion is connected to one side of the positioning portion, and the actuating portion and the positioning portion is capable of pivoting relative to the swing member between a first position and a second position;
another side of the positioning portion that is not connected to the extension portion includes a limiting groove, the limiting groove is communicated with the ratchet tooth groove, and includes a first corner and a second corner located on opposite sides of the limiting groove;
a ratchet block assembly disposed in the ratchet tooth groove, and including a first ratchet block, a second ratchet block and a second elastic member, wherein one end of the second elastic member abuts against the first ratchet block, another end of the second elastic member abuts against the second ratchet block, the first ratchet block includes a first protrusion, the second ratchet block includes a second protrusion, the first protrusion and the second protrusion extend into the limiting groove, when the positioning portion is in the first position, the second protrusion is located at the first corner, and the first protrusion is away from the second corner, when the positioning portion is in the second position, the second protrusion is away from the first corner, and the first protrusion is located at the second corner.

2. The electric ratchet wrench as claimed in claim 1, wherein the swing member is provided with a groove, the ratchet tooth groove is communicated with the groove and the ratchet hole, and the positioning portion is disposed in the groove.

3. The electric ratchet wrench as claimed in claim 1, wherein the ratchet hole penetrates a top end surface and a bottom end surface of the swing member, the swing member further includes a secondary top surface, a slot is formed between the secondary top surface and the top end surface, and the positioning portion is disposed in the slot.

4. The electric ratchet wrench as claimed in claim 2, wherein another side of the positioning portion that is not connected to the extension portion includes a first positioning groove and a second positioning groove;
the swing member includes a positioning-member accommodating groove which communicates with the groove;
a positioning assembly includes a positioning member and a first elastic member, the first elastic member is disposed in the positioning-member accommodating groove, with one end of the first elastic member abutting against the positioning-member accommodating groove, and another end abutting against the positioning member, when the positioning portion is in the first position, the positioning member abuts against the first positioning groove, and when the positioning portion is in the second position, the positioning member abuts against the second positioning groove.

5. The electric ratchet wrench as claimed in claim 3, wherein another side of the positioning portion that is not connected to the extension portion includes a first positioning groove and a second positioning groove;
the swing member includes a positioning-member accommodating groove which is located on the secondary top surface;
a positioning assembly includes a positioning member and a first elastic member, the first elastic member is disposed in the positioning-member accommodating groove, with one end of the first elastic member abutting against the positioning-member accommodating groove, and another end abutting against the positioning member, when the positioning portion is in the first position, the positioning member abuts against the first positioning groove, and when the positioning portion is in the second position, the positioning member abuts against the second positioning groove.

6. The electric ratchet wrench as claimed in claim 1, wherein a surface of the first clamping piece facing the second clamping piece is a first inner surface, a surface of the second clamping piece facing the first clamping piece is a second inner surface, the first inner surface includes a first groove, and the second inner surface includes a second groove.

7. The electric ratchet wrench as claimed in claim 1, wherein the swing member is provided with a groove along an axial direction of an imaginary pivot axis, the groove is provided with a first recessed edge on an inner peripheral edge thereof in a radial direction of the imaginary pivot axis, the positioning portion is provided with a second recessed edge on an outer peripheral edge thereof in the radial direction of the imaginary pivot axis, a snap ring is sleeved on the positioning portion, and is disposed in the first recessed edge and the second recessed edge.

8. The electric ratchet wrench as claimed in claim 4, wherein a ridge portion is provided between the first positioning groove and the second positioning groove, the first positioning groove corresponds to a first groove bottom, the second positioning groove corresponds to a second groove bottom, the first groove bottom and the second groove bottom are triangular and inclined, one end of the first groove bottom and one end of the second groove bottom jointly form the ridge portion, and the ridge portion is a sharp angle where the first groove bottom and the second groove bottom are connected.

9. The electric ratchet wrench as claimed in claim 5, wherein a ridge portion is provided between the first positioning groove and the second positioning groove, the first positioning groove corresponds to a first groove bottom, the second positioning groove corresponds to a second groove bottom, the first groove bottom and the second groove bottom are triangular and inclined, one end of the first groove bottom and one end of the second groove bottom jointly form the ridge portion, and the ridge portion is a sharp angle where the first groove bottom and the second groove bottom are connected.

10. The electric ratchet wrench as claimed in claim 8, wherein one side of the positioning portion that is not connected to the extension portion includes a bottom surface, and the bottom surface is coplanar with the ridge portion.

11. The electric ratchet wrench as claimed in claim 9, wherein one side of the positioning portion that is not connected to the extension portion includes a bottom surface, and the bottom surface is coplanar with the ridge portion.
